(19) United States
(12) Patent Application Publication
(10) Pub. No.: US 2011/0292999 A1
(43) Pub. Date: Dec. 1, 2011

(54) SUPER MACRO BLOCK BASED INTRA CODING METHOD AND APPARATUS

(75) Inventors: Se Yoon JEONG, Daejeon (KR); Sung-Chang Lim, Daejeon (KR); Hahyun Lee, Seoul (KR); Jinho Lee, Daejeon (KR); Jongho Kim, Daejeon (KR); Hae-Chul Choi, Daejeon (KR); Sukhee Cho, Daejeon (KR); Hui Yong Kim, Daejeon (KR); Jin Soo Choi, Daejeon (KR); Jin Woo Hong, Daejeon (KR)

(73) Assignee: Electronics and Telecommunications Research Institute, Daejeon (KR)

(21) Appl. No.: 12/827,195

(22) Filed: Jun. 30, 2010

(30) Foreign Application Priority Data
May 31, 2010 (KR) 10-2010-0051018
Jun. 30, 2010 (KR) 10-2009-0059241

(51) Int. Cl. H04N 7/32

(52) U.S. Cl. 375/240.12; 375/E07.243

(57) ABSTRACT

Provided are technologies that may perform intra coding of a super macro block that is an enlarged macro block. In this case, the super macro block is handled as a single entity or may be divided into a plurality of macro blocks. The present invention may perform intra coding both when the super macro block is handled as the single entity and when the super macro block is divided into the plurality of macro blocks.

### CROSS-REFERENCE TO RELATED APPLICATION

This application claims the benefit of Korean Patent Application Nos. 10-2009-0059241 filed on Jun. 30, 2009 and 10-2010-0051018 filed on May 31, 2010 in the Korean Intellectual Property Office, the disclosure of which is incorporated herein by reference.

### BACKGROUND

1. Field of the Invention

The present invention relates to an intra coding method and apparatus, and more particularly, to an intra coding method and apparatus based on a super macro block that is not conventionally used for intra coding.

2. Description of the Related Art

A video coding scheme may be roughly classified into an inter coding scheme and an intra coding scheme. Generally, the intra coding scheme may process a video based on a macro block unit having a size of 16×16. The intra coding scheme may support a video of which a maximum resolution is at a high definition (HD) level.

To support a video having a resolution higher than the HD level, the macro block may be enlarged. Specifically, according to a conventional art, the inter coding scheme may support the enlarged macro block, herein after referred to as a super macro block. However, the intra coding scheme may not support the super macro block.

### SUMMARY

An aspect of the present invention provides an intra coding method and apparatus that may enable a super macro block to be used for an intra coding.

Another aspect of the present invention also provides an intra coding method and apparatus that may use a super macro block for performing intra coding and may optimize the use of the super macro block to improve a coding performance.

Another aspect of the present invention also provides an intra coding method and apparatus based on a H.264 video compression standard which is well known.

According to an aspect of the present invention, there is provided an intra coding method, and the method may include receiving a super macro block, generating a bit stream by performing, with respect to the super macro block, an intra prediction, transcoding, quantizing, and entropy coding, when the super macro block is handled as a single entity, and marking a flag to indicate that the super macro block is handled as the single entity.

The super macro block may have a size of 16n×16n, n being a natural number greater than or equal to 2.

The indicating may include marking a first logical value when the super macro block is handled as the single entity, and marking a second logical value when the super macro block is divided into a plurality of blocks and each of the plurality of blocks is handled as a single entity.

The generating may include performing the intra prediction with respect to the super macro block using a prediction mode ‘Intra 32×32’, when n is 2, and the prediction mode ‘Intra 32×32’ is defined based on a prediction mode ‘Intra 16×16’ that is applied to a macro block having a size of 16×16 among prediction modes defined based on a video compression standard H.264.

The prediction mode ‘Intra 32×32’ may include a horizontal prediction mode, a vertical prediction mode, a DC (discrete cosine) prediction mode, and a plane prediction mode.

The generating may include performing an 8×8 integer cosine transformation with respect to differential blocks generated from the super macro block, when n is 2, and collecting DC values generated by performing an integer cosine transformation, and performing, with respect to the collected DC values, a 4×4 Hadamard transformation that is applied to a macro block having a size of 16×16 among prediction modes defined based on a video compression standard H.264.

The generating may include performing an 8×8 integer cosine transformation with respect to differential blocks generated from the super macro block, when n is 2, and collecting DC values generated by performing an integer cosine transformation, and performing, with respect to the collected DC values, a 2×2 Hadamard transformation that is applied to a macro block having a size of 16×16 among prediction modes defined based on a video compression standard H.264.

The intra coding method may further include generating, for each super macro block, a parameter ‘smb_qp_delta’ associated with an error generated while the intra prediction with respect to each super macro block is performed.

The intra coding method may further include marking a flag to indicate whether the super macro block is a last super macro block in a corresponding slice.

According to an aspect of the present invention, there is provided an intra coding method, the method may include dividing a super macro block into M macro blocks, M being a natural number greater than or equal to 2, generating a bit stream by performing, with respect to each of the M macro blocks, an intra prediction, transcoding, quantizing, and entropy coding, and marking a flag to indicate that the super macro block is divided into M macro blocks.

The super macro block may have a size of 16n×16n, n being a natural number greater than or equal to 2.

The marking of the flag may include marking a first logical value when the super macro block is handled as a single entity, and marking a second logical value when the super macro block is divided into M macro blocks and each of the macro blocks is handled as a single entity.

The generating may include performing the intra prediction with respect to each of the M macro blocks using a prediction mode ‘Modified Intra 16×16’, when n is 2 and M is 4, and the prediction mode ‘Modified Intra 16×16’ is defined based on a prediction mode ‘Intra 8×8’ that is applied to a macro block having a size of 8×8 among prediction modes defined based on a video compression standard H.264.

The prediction mode ‘Modified Intra 16×16’ may include a vertical prediction mode, a horizontal prediction mode, a DC prediction mode, a diagonal down left prediction mode, a diagonal down right prediction mode, a vertical right prediction mode, a horizontal down prediction mode, a vertical left prediction mode, and a horizontal up prediction mode.

The intra coding method may further include generating, for each super macro block, a parameter ‘smb_qp_delta’ associated with an error generated while the intra prediction with respect to each super macro block is performed.

The intra coding method may further include marking a flag indicating whether the super macro block is a last super macro block in a corresponding slice.

The intra coding method may further include indicating, based on a most probable mode (MPM) flag scheme, each of the vertical prediction mode, the horizontal prediction mode, the DC prediction mode, the diagonal down left prediction mode, the diagonal down right prediction mode, the vertical right prediction mode, the horizontal down prediction mode, the vertical left prediction mode, and the horizontal up prediction mode.

The prediction mode ‘Modified Intra 16×16’ is defined based on a 16×16 inter transform that is used for an inter prediction with respect to the super macro block in KTA (key technical area (KTA)) 2.3 software.

According to an aspect of the present invention, there is provided an intra coding apparatus, and the apparatus includes an intra predictor to receive a super macro block and to perform an intra prediction with respect to the super macro block, a transcoder to perform transcoding with respect to differential blocks generated based on the super macro block and a result of the intra prediction, and a quantizer to perform quantizing with respect to an output of the transcoder, an entropy coder to perform coding with respect to an output of the quantizer to generate a bit stream, and a flag is marked to indicate that the super macro block is handled as a single entity.

The super macro block may have a size of 16n×16n, n being a natural number greater than or equal to 2.

According to an aspect of the present invention, there is provided an intra coding apparatus, and the apparatus includes an intra predictor to divide a super macro block into M macro blocks, M being a natural number greater than or equal to 2, and to perform an intra prediction with respect to each of the M macro blocks, a transcoder to perform transcoding with respect to differential blocks generated based on the M macro blocks and a result of the intra prediction, a quantizer to perform quantizing an output of the transcoder, and an entropy coder to perform entropy coding with respect to an output of the quantizer to generate a bit stream, and a flag is marked to indicate that the super macro block is divided into the M macro blocks.

The super macro block may have a size of 16n×16n, n being a natural number greater than or equal to 2.

Additional aspects, features, and/or advantages of the invention will be set forth in part in the description which follows and, in part, will be apparent from the description, or may be learned by practice of the invention.

### EFFECT

An aspect of the present invention provides an intra coding method and apparatus that may enable a super macro block to be used for an intra coding.

Another aspect of the present invention also provides an intra coding method and apparatus that may use a super macro block for performing intra coding and may optimize the use of the super macro block to improve a coding performance.

Another aspect of the present invention also provides an intra coding method and apparatus based on an H.264 video compression standard which is well known.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 is a block diagram illustrating a (conventional?) coding apparatus that performs conventional intra coding and conventional inter coding;

FIG. 2 is a diagram illustrating an example of a partitioning of a super macro block according to an embodiment of the present invention;

FIG. 3 illustrates a table illustrating types of a super macro block having a size of 32×32 based on a prediction mode and a coded block pattern;

FIG. 4 illustrates a table defining four macro blocks as a single type, and where a super macro block having a size of 32×32 is divided into four macro blocks, a macro block has a size of 16×16;

FIG. 5 illustrates a table illustrating nine prediction modes of a prediction mode ‘modified intra 16×16’ that is applied when a super macro block having a size of 32×32 is divided into four macro blocks, a macro block having a size of 16×16;

FIG. 6 illustrates a table defining a prediction mode, a Luma transformation, a Chroma transformation, and a coded block pattern for each of a super macro block having a size of 32×32, a macro block having a size of 16×16, a macro block having a size of 8×8, and a macro block having a size of 4×4;

FIG. 7 is a diagram hierarchically illustrating possible partitions of a super macro block having a size of 32×32;

FIG. 8 is a flowchart illustrating an intra coding method according to an embodiment of the present invention; and

FIG. 9 is a block diagram illustrating a coding apparatus including an intra coding apparatus according to an embodiment.

### DETAILED DESCRIPTION

Reference will now be made in detail to embodiments of the present invention, examples of which are illustrated in the accompanying drawings, wherein like reference numerals refer to the like elements throughout. Embodiments are described below to explain the present invention by referring to the figures.

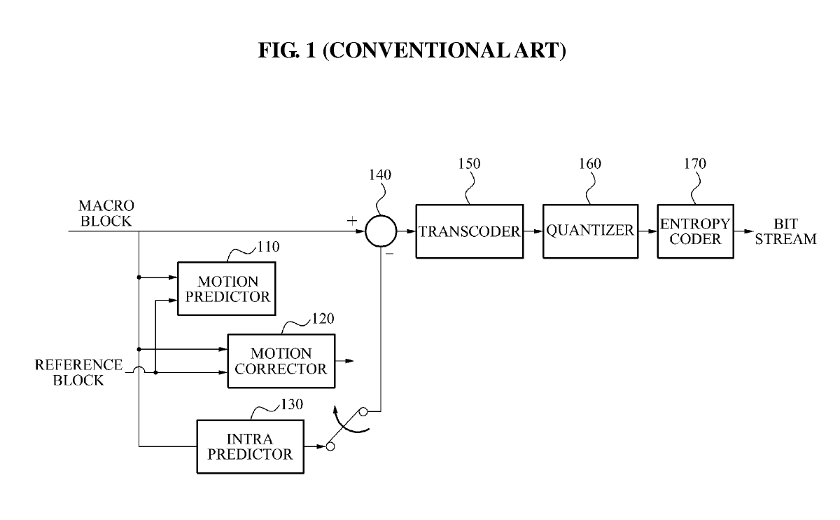

FIG. 1 illustrates a (conventional?) coding apparatus that performs conventional intra coding and conventional inter coding.

Referring to FIG. 1, the coding apparatus may include a motion predictor 110, a motion corrector 120, an intra predictor 130, a combining unit 140, a transcoder 150, a quantizer 160, and an entropy coder 170.

The motion predictor 110 and the motion corrector 120 may be used for an inter prediction in a inter mode. The motion predictor 110 may predict a motion vector between a macro block that is a target of coding and a reference block, and the motion corrector 120 may generate a prediction block based on the motion vector.

The intra predictor 130 may be used for an intra prediction in an intra mode. The intra prediction may generate a prediction block without referring to an external reference block. In this case, the intra predictor 130 may generate the prediction block based on one of various prediction modes.

Various technologies including H.264, which is a well known video compression standard, may be used to perform the intra prediction based on a macro block unit. Specifically, an intra prediction of H.264 may not support an enlarged macro block, namely, a super macro block, having a size larger than a macro block having a size of 16×16. According to embodiments, an optimal solution for the intra prediction may be provided, and the optimal solution may support the super macro block.

When the prediction block is generated by the intra predictor 130, the combining unit 140 may generate a differential block based on a subtraction between the macro block and the prediction block. The transcoder 150 may perform a Luma transform and a Chroma transform with respect to the differential block. The quantizer 160 may perform quantizing with respect to an output of the transcoder 150, and the quantized result may be entropy-coded by the entropy coder 170. In this case, rearrangement may be performed prior to the entropy coding.

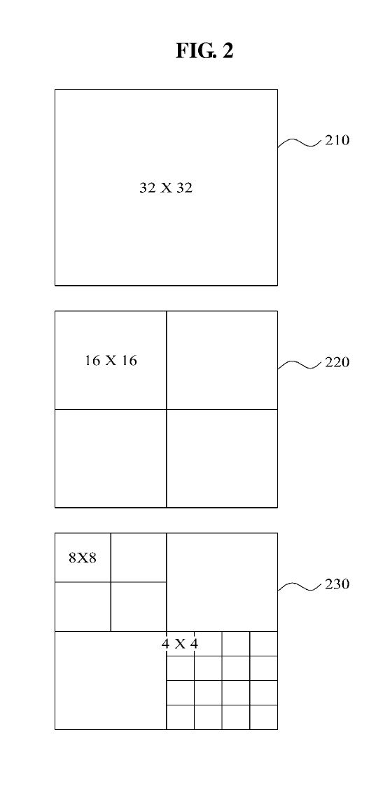

FIG. 2 illustrates an example of a partitioning of a super macro block according to an embodiment of the present invention.

Referring to FIG. 2, a super macro block 210 having a size of 32×32 may be provided. The super macro block may be handled as a basic process unit of inter coding, and the size of the super macro block may be determined as 16n×16n, such as 64×64 and 128×128. Here, n is a natural number greater than or equal to 2.

The super macro block 210 may be intra coded as a single entity without partitioned the super macro block 210, and the super macro block 210 may be partitioned into four or more macro blocks. Specifically, the super macro block 220 may be partitioned into four macro blocks having sizes of 16×16, and may be divided into a plurality of macro blocks having sizes of 8×8 and may be divided into a plurality of macro blocks having sizes of 4×4 as shown by a super macro block 230.

Hereinafter, an example where the super macro block having the size of 32×32 is handled as a single entity while being intra-coded and an example where the super macro block having the size of 32×32 is divided into a plurality of macro blocks and is intra coded are described.

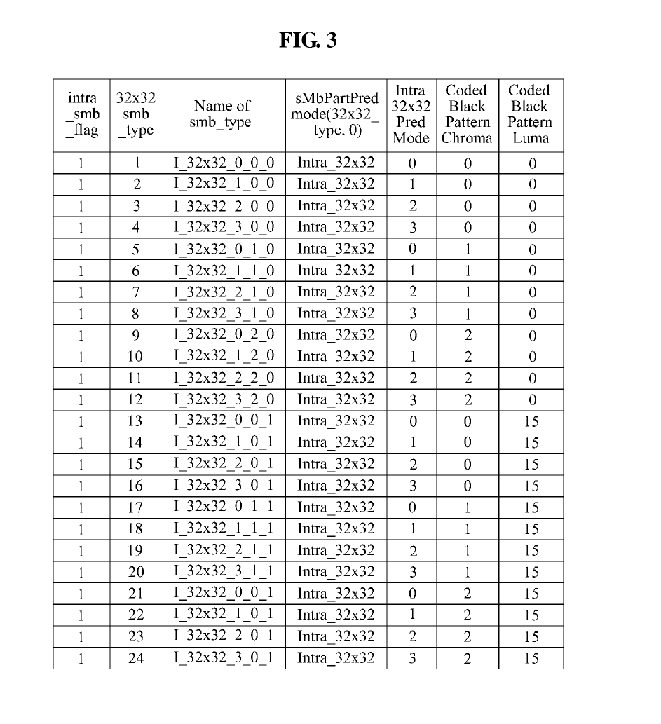

FIG. 3 illustrates a table illustrating types of a super macro block having a size of 32×32 based on a prediction mode and a coded block pattern.

Referring to FIG. 3, a flag, namely, ‘intra_smb_flag’ may indicate whether the super macro block having a size of 32×32 is handled as a single entity while being intra coded, or whether the super macro block having the size of 32×32 is divided into a plurality of macro blocks to be intra coded. When the super macro block having a size of 32×32 is handled as the single entity, ‘intra_smb_flag’ may be set to a first logical value, namely, ‘1’, and when the super macro block having the size of 32×32 is divided into four macro blocks to be intra coded, ‘intra_smb_flag’ may be set to a second logical value, namely, ‘0’. In this case, the four macro blocks may be coded using Raster scan, and Raster scan sequencing may be variously set based on a slice header or a picture header.

As described above, H.264 that is well-known in the art may not intra code the super macro block having the size of 32×32 as a single entity. However, according to an embodiment of the present invention, it is possible to define an intra prediction mode Intra_{—}32×32 used for intra coding the super macro block having the size of 32×32 as a single entity based on an intra prediction mode intra 16×16 that is defined in the H.264 for intra coding a macro block having a size of 16×16. According to an embodiment of the present invention, the intra predication mode Intra_{—}32×32 for intra coding the super macro block having a size of 32×32 as a single entity may be defined based on H.264, to effectively use codes specified in H.264.

32×32smb_type that is a type of the super macro block having a size of 32×32 may indicate that the intra prediction mode Intra_{—}32×32 is applied to the super macro block having the size of 32×32, may indicate a detailed type of the prediction mode Intra_{—}32×32, and may indicate a coded block pattern generated from each of a Chroma transformation and a Luma transformation. The intra coding apparatus may indicate, based on 32×32smb_type, the detailed type of intra prediction mode Intra_{—}32×32 applied to the super macro block having the size of 32×32, and the coded block pattern generated from each of the Chroma transformation and Luma transformation, and an intra decoding apparatus may also recognize the described information based on 32×32smb_type.

The intra prediction mode Intra_{—}32×32 applied to the super macro block having the size of 32×32 may include four prediction modes, like the prediction mode Intra 16×16 defined in H.264. The prediction mode Intra 16×16 defined in H.264 may include a horizontal prediction mode, a vertical prediction mode, a DC (discrete cosine) prediction mode, and a plane prediction mode, and the intra prediction mode Intra_{—}32×32 applied to the super macro block having the size of 32×32 may also include a horizontal prediction mode, a vertical prediction mode, a DC prediction mode, a plane prediction mode.

The horizontal prediction mode, the vertical prediction mode, the DC prediction mode, and the plane prediction mode included in the intra prediction mode Intra_{—}32×32 may use codes defined in H.264. However, the size of the super macro block is 32×32, and a, b, c, H, and V required in the plane prediction mode may be corrected as below.

$$a = 16 \times ( P ( - 1 , 31 ) + P ( 31 , - 1 ) )$$

$$b = 5 \times ( H / 512 )$$

$$c = 5 \times ( V / 512 )$$

$$Pred ( i , j ) = ( a + bx ( i - 7 ) + cx ( j - 7 ) + 16 ) / 32$$

$$H = {\sum }_{i = 1}^{32} ix ( P ( 31 + i , - 1 ) - P ( 31 - i , - 1 ) )$$

$$V = {\sum }_{j = 1}^{32} jx ( P ( - 1 , 31 + j ) - P ( - 1 , 31 - j ) )$$

Each of the horizontal prediction mode, the vertical prediction mode, the DC prediction mode, and the plane prediction mode included in the intra prediction mode Intra_{—}32×32 may be identified based on ‘intra32×32PredMode’, and ‘intra32×32PredMode’ may be indicated by 32×32smb_type.

When the intra prediction is completed, a signal of a differential block may be transcoded and quantized. In this case, the trascoding may include the Luma transformation and the Chroma transformation. The Lumar transformation may perform an 8×8 integer cosine transformation to collect DCs, and may perform a 4×4. Hadamard transformation with respect to the DCs. The Chroma transformation may perform the 8×8 integer cosine transformation to collect DCs, and may perform a 2×2 Hadamard transformation with respect to the DCs. For reference, a Luma transformation of Intra 16×16 of H.264 performs the 4×4 Hadamard transformation, and thus, the Luma transformation of this application may effectively utilize codes of H.264.

A coded block pattern indicating a coefficient remaining after the quantizing may be recognized based on 32×32smb_type. Specifically, ‘CodedBlockPatternLuma’ that is a coded block pattern associated with the Luma transformation may have one of ‘0’ and ‘15’ based on the coefficient, and ‘CodedBlockPatternChroma’ that is a coded block pattern associated with the Chroma transformation may have one of ‘0’, ‘1’, ‘2’, and ‘3’ based on the coefficient. ‘CodedBlockPatternLuma’ and ‘CodedBlockPatternChroma’ may be indicated by 32×32smb_type. For example, referring to FIG. 3, when a value of 32×32smb_type is ‘5’, ‘CodedBlockPatternLuma’ is 0 and ‘CodedBlockPatternChroma’ is 1.

A different ‘name of smb_type’ may be assigned to each 32×32smb_type.

H.264 may mark a parameter associated with an error occurring while the intra prediction is performed, using mb_qp_delta for each macro block. In this case, ‘smb_qp_delta’ is recorded based on a super macro block unit, and thus, the parameter associated with the error occurring while intra prediction is performed with respect to the super macro block. ‘smb_qp_delta’ is recorded based on the super macro block unit as opposed to being based on the macro block and thus, a coding performance may be improved. A specific application may require an accurate rate control, ‘smb_qp_delta’ and ‘mb_qp_delta’ may be simultaneously used, or mb_qp_delta for the specific application may only be used. ‘smb_qp_delta’ and ‘mb_qp_delta’ may be processed in an higher level, such as a slice header or a picture header.

When H.264 uses Context Adaptive Binary Arithmetic Coding (CABAC), H.264 marks end_of slice_flag for each macro block to indicate whether a corresponding macro block is a last macro block in a corresponding slice. Specifically, end_of slice_flag of ‘0’ indicates that a subsequent macro block to be decoded remains, end_of slice_flag of ‘1’ indicates that the corresponding macro block is the last macro block in the corresponding slice.

However, end_of slice_flag may be marked based on the super macro block unit. When a size of a screen is not a multiple of an integer and the size of the super macro block, end_of slice_flag may be inserted in a last portion of a last block.

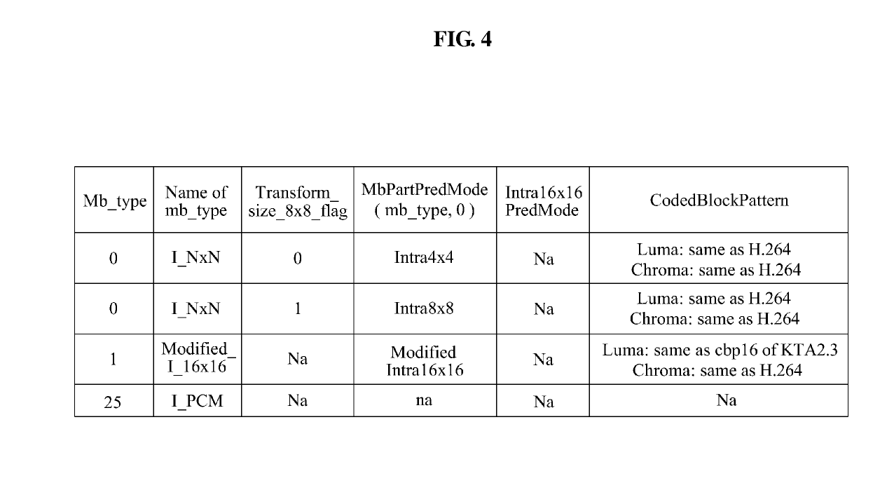

FIG. 4 illustrates a table defining four macro blocks as a single type, and where a super macro block having a size of 32×32 is divided into four macro blocks, a macro block has a size of 16×16.

When the super macro block having the size of 32×32 is divided into four macro blocks having sizes of 16×16, each of the four macro blocks may be intra coded using Intra 16×16 defined in H.264. According to an embodiment of the present invention, a new intra prediction mode Modified intra 16×16 may be provided. Here, Modified intra 16×16 may be defined based on ‘Intra 8×8’ defined by H.264.

Referring to FIG. 4, an intra predication mode of Modified intra 16×16 may be applied to each of the four macro blocks having sizes of 16×16. In this case, the intra predication mode of Modified intra 16×16 may include nine prediction modes, similar to ‘Intra 8×8’ defined by H.264. In addition, the intra prediction mode of Modified intra 16×16 may process a block having a size greater than ‘Intra 8×8’ defined in H.264, and thus, may support nine or more prediction modes. Accordingly, a coding performance may be improved.

When the intra prediction mode of Modified intra 16×16 is applied to a macro block having a size of 16×16, a type of the macro block having the size of 16×16 may be defined as ‘1’, regardless of the nine or more prediction modes included in the intra prediction mode of Modified intra 16×16. The type of the macro block having the size of 16×16 may be defined as a value of 2 through 24, and may be defined as a new value, for example, 26.

Referring to FIG. 3, SMb_type of 0 and 25 may be maintained to be the same as defined in H.264.

As illustrated in FIG. 3, the intra prediction mode of Modified intra 16×16 may perform a Luma transformation using 16×16 inter transform for inter coding of the super macro bock in KTA (key technical area) 2.3 software. The intra prediction mode of Modified intra 16×16 may perform a Chroma transformation using technologies defined in H.264.

In this case, the intra prediction mode of Modified intra 16×16 may adopt a scheme of using an MDDT (a Mode-Dependent Directional Transform), or may use an optimal transformation size through rate optimizing.

A coefficient remaining after quantizing associated with the Luma transformation may be coded into one-bit cbp (coded block pattern) 16 defined in KTA 2.3 software. When a value of cbp16 is 0, the value indicates that a coded coefficient may not exist, and when a value of cbp16 is 1, the value indicates that a coded coefficient exists.

The Chroma transformation may use 2×2 Hadamard transformation and 4×4 integer cosine transformation (specified in H.264?), and a coefficient remaining after quantizing associated with the Chroma transformation may be expressed by a two-bit CBP.

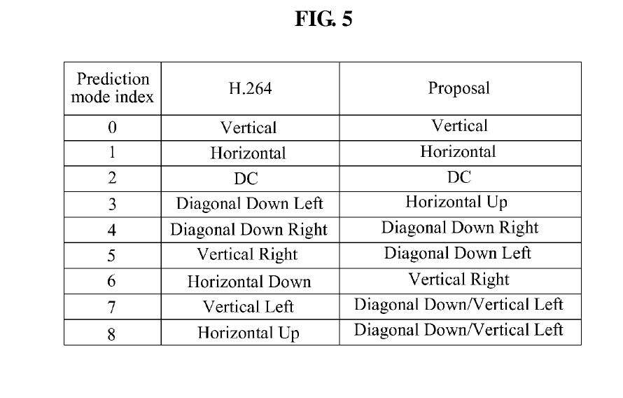

FIG. 5 illustrates a table illustrating nine prediction modes of a prediction mode ‘modified intra 16×16’ that is applied when a super macro block having a size of 32×32 is divided into four macro blocks, a macro block having a size of 16×16.

As described in FIG. 4, when the super macro block having a size of 32×32 is divided into four macro blocks having sizes of 16×16, a prediction mode ‘modified intra 16×16’ may be applied. The prediction mode ‘modified intra 16×16’ may include nine or more prediction modes, and FIG. 5 illustrates nine prediction modes among the nine or more prediction modes.

Referring to FIG. 5, prediction modes that intra 8×8 may include in H.264 may be a vertical prediction mode, a horizontal prediction mode, a DC prediction mode, a diagonal down left prediction mode, a diagonal down right prediction mode, a vertical right prediction mode, a horizontal down prediction mode, a vertical left prediction mode, and a horizontal up prediction mode.

According to an embodiment of the present invention, it is also possible to include the described nine prediction modes. Indexes assigned to the prediction modes may be based on H.264 or may be newly assigned as illustrated in FIG. 5. In addition, statistically optimal indexes may be assigned to prediction modes.

A minimum of four-bits may be used for coding the indexes of the nine prediction modes. According to an embodiment of the present invention, a Most Probable Mode (MPM) flag scheme of H.264 may be used to perform coding of the indexes of the nine prediction modes. A smallest index among prediction modes of adjacent macro blocks including a left macro block and an upper macro block may be regarded as MPM_{—}16. When an index of a prediction mode of a target macro block is the same as the smallest index, the index of the prediction mode of the target macro block is coded to ‘1’, otherwise, the index of the prediction mode of the target macro block may be coded as ‘0’. In this case, three remaining bits among four bits may be used for indicating one of eight remaining prediction modes.

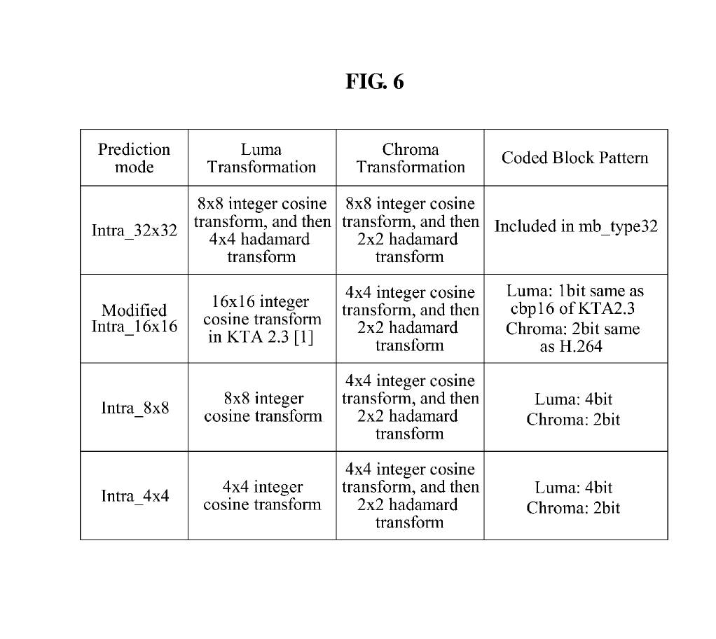

FIG. 6 illustrates a table defining a prediction mode, a Luma transformation, a Chroma transformation, and a coded block pattern for each of a super macro block having a size of 32×32, a macro block having a size of 16×16, a macro block having a size of 8×8, and a macro block having a size of 4×4

Referring to FIG. 6, it may be recognized that the described contents may be summarized in FIG. 6.

A prediction mode Intra 32×32 may be applied to a super macro block having a size of 32×32. The prediction mode Intra 32×32 may include an 8×8 integer cosine transformation and a 4×4 Hadamard transformation, as a Luma transformation. The prediction mode Intra 32×32 may include the 8×8 integer cosine transformation and a 2×2 Hadamard transformation, as a Chroma transformation. CBP may be indicated by a type of the super macro block.

A prediction mode modified intra 16×16 may be applied to each of macro blocks having sizes of 16×16. A Luma transformation of the prediction mode modified intra 16×16 may include a 16×16 integer cosine transformation defined in KTA 2.3, and a Chroma transformation of the prediction mode modified intra 16×16 may include a 4×4 integer cosine transformation and a 2×2 Hadamard transformation. In this case, a quantization parameter associated with the Luma transformation may be expressed by one bit such as cbp 16 of KTA 2.3, and a quantization parameter associated with the Chroma transformation may be expressed by two bits as defined in H.264.

A prediction mode intra 8×8 may be applied to each of macro blocks having sizes of 8×8. A Luma transformation of the predication mode intra 8×8 may include a 4×4 integer cosine transformation and 2×2 Hadamard transformation, and a Chroma transformation of the predication mode intra 8×8 may include the 4×4 integer cosine transformation and 2×2 Hadamard transformation. In this case, a quantization parameter associated with the Luma transformation may be expressed by four bits, and a quantization parameter associated with the Chroma transformation may be expressed by two bits.

A prediction mode intra 4×4 may be applied to each of macro blocks having a size of 4×4. A Luma transformation of the prediction mode intra 4×4 may include a 4×4 integer cosine transformation, a Chroma transformation of the prediction mode intra 4×4 may include a 4×4 integer cosine transformation and a 2×2 Hadamard transformation. In this case, a quantization parameter associated with the Luma transformation may be expressed by four bits, and a quantization parameter associated with the Chroma transformation may be expressed by two bits.

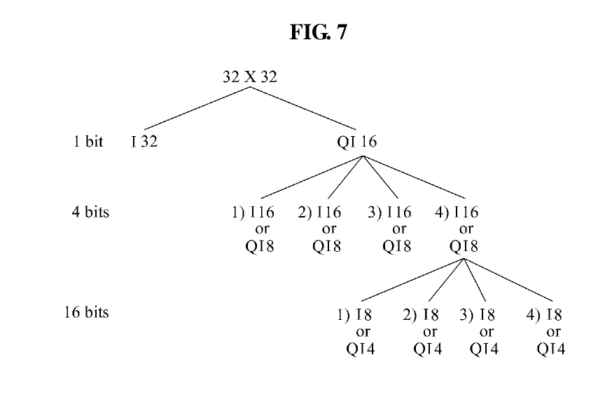

FIG. 7 hierarchically illustrating possible partitions of a super macro block having a size of 32×32.

According to an embodiment of the present invention, it is possible to have a high compatibility with H.264, and to be applicable to an application that is not compatible with H.264. Specifically, it is possible to be applied to a macro block having a size that is not supported by H.264. For example, as illustrated in FIG. 7, Quad-Tree Partition may be applied to perform intra coding a macro block having a size that is not supported by H.264.

Q of FIG. 7 denotes Quadrature, and I denotes In phase. For example, I32 indicates 32×32 and 32×16, and QI16 indicates 16×16. I32 and QI16 may be identified based on one bit. In addition, macro blocks in a layer including four I16 or four QI18 may be identified based on four bits, and macro blocks in a layer including four I8 or four QI4 may be identified based on 16 bits.

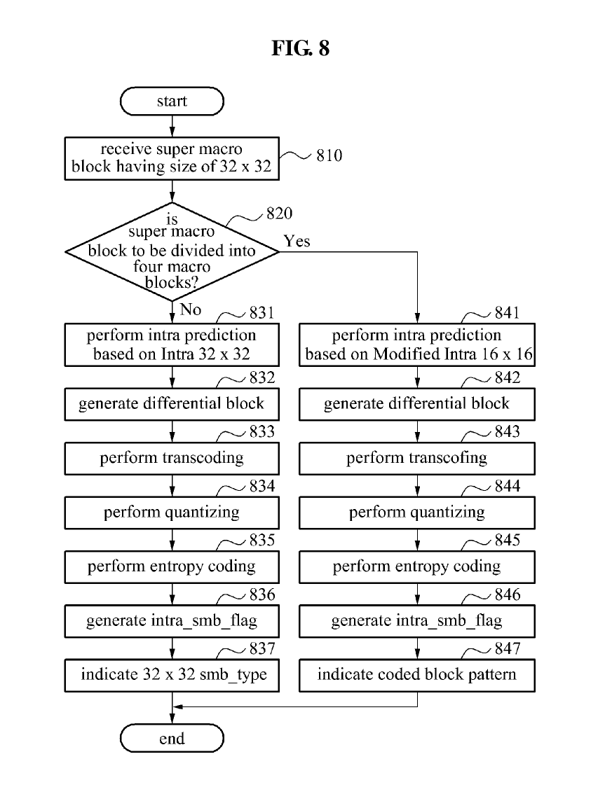

FIG. 8 illustrates an intra coding method according to an embodiment. Referring to FIG. 8, the intra coding method receives a super macro block having a size of 16n×16n in operation 810, and n is ‘2’. Whether the super macro block is to be divided into four macro block is determined in operation 820.

When the super macro block is handled as a single entity, the intra coding method performs an intra prediction with respect to the super macro block using Intra 32×32 in operation 831. The Intra coding method generates a differential block in operation 832 and performs a transcoding in operation 833. The intra coding method performs quantizing in operation 834 and performs entropy coding in operation 835. The described intra coding method with respect to the super macro block may be applied, as is, to operations 831 through 835 and thus, detailed descriptions thereof are omitted. The intra coding method may mark a flag of 1, namely, intra_smb_flag, indicating that the super macro block is handled as a single entity in operation 836, and indicates a type of the super macro block, namely 32×32 smb_type, in operation 837.

When the super macro block is divided into four macro blocks, the intra coding method performs intra prediction using Modified Intra 16×16 in operation 841. In this case, a differential block is generated in operation 842, a trans coding is performed in operation 843, a quantizing is performed in operation 844, and entropy coding is performed in operation 845, sequentially. In operation 846, a flag of ‘0’, namely, intra_smb_flag, indicates that the super macro block is divided. As described with reference to FIG. 6, a CBP is indicated in operation 847.

According to an embodiment of the present invention, although a case where a size of a super macro block is 32×32 is described as an example, it is possible to be applicable to a super macro block having a size of 64×64 or 128×128, and it is possible to be applicable to a macro block having a size of 8×8 or 4×4.

An intra decoding method may be embodied by performing operations included in the intra coding method in a reverse order. Specifically, the descriptions about the intra coding method may be applicable to the intra decoding method and thus, detailed descriptions thereof are omitted. Hereinafter, examples of embodying the intra decoding method are provided.

First, it is assumed that a super macro block is handled as a single entity when the super macro block is coded. In this case, the intra decoding method may receive a bit stream corresponding to an intra coded super macro block. The intra decoding method may recognize that the super macro block is handled as a single entity while being coded, based on a flag of the intra coded super macro block, namely, intra_smb_flag. In this case, the intra decoding method may perform entropy decoding, dequantizing, trans decoding, and an intra prediction with respect to the bit stream in response to the recognizing, and thus, may restore the super macro block. The super macro block has a size of 16n×16n, and n is a natural number greater than or equal to 2, and the restoring of the super macro block may include an operation of performing intra prediction with respect to the super macro block using a predication mode ‘Intra 32×32’, when n is 2.

Second, it is assumed that a super macro block is divided into M macro blocks to be coded. In this case, the intra decoding method may receive a bit stream corresponding to an intra coded super macro block. The intra decoding method may recognize that the super macro block is divided into M macro blocks to be coded and M is a natural number greater than or equal to 2, based on a flag of the intra coded super macro block. In this case, the intra decoding method may perform entropy decoding, dequantizing, trans decoding, and an intra prediction with respect to the bit stream in response to the recognizing, and thus, may restore the super macro block. The super macro block has a size of 16n×16n, and n is a natural number greater than or equal to 2, and the restoring of the super macro block may include an operation of performing an intra prediction with respect to each of the M macro blocks using a predication mode ‘Modified Intra 16×16’, when n is 2 and M is 4. The prediction mode ‘Modified Intra 16×16’ may be defined based on a prediction mode ‘Intra 8×8’ that is applied to a macro block having a size of 8×8 among prediction modes defined in a video compression standard H.264

The method according to the above-described embodiments of the present invention may be recorded in non-transitory computer readable media including program instructions to implement various operations embodied by a computer. The media may also include, alone or in combination with the program instructions, data files, data structures, and the like. Examples of non-transitory computer readable media include magnetic media such as hard disks, floppy disks, and magnetic tape; optical media such as CD ROM disks and DVDs; magneto-optical media such as floptical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention, or vice versa.

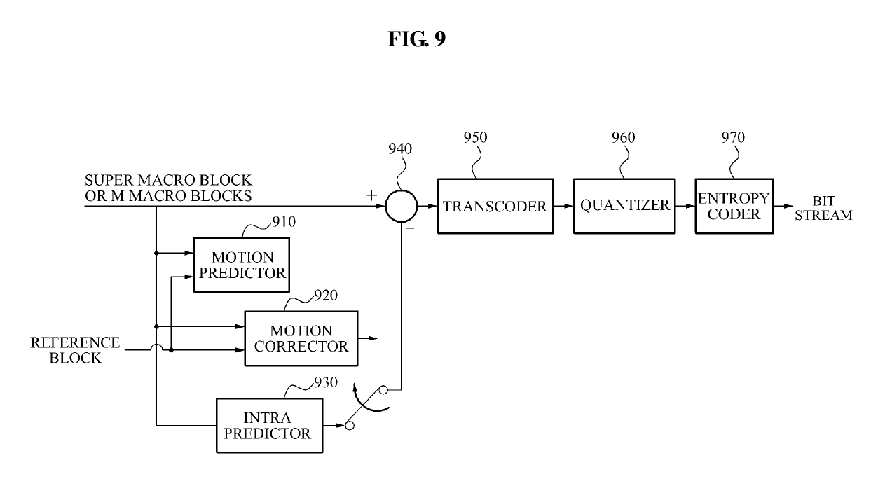

FIG. 9 illustrates a coding apparatus including an intra coding apparatus according to an embodiment.

Referring to FIG. 9, the coding apparatus may include a motion predictor 910, a motion corrector 920, an intra predictor 930, a combining unit 940, a transcoder 950, a quantizer 960, and an entropy coder 970.

The motion predictor 910 and the motion corrector 920 operate in an inter mode, and thus, detailed descriptions thereof are omitted.

The intra predictor 930 may receive a super macro block having a size of 16n×16n, n being a natural number greater than or equal to 2, and may perform an intra predication with respect to the super macro block. In this case, the intra predictor 930 may handle the super macro block as a single entity or may divide the super macro block into a plurality of macro blocks.

Subtraction between a prediction block generated by the intra predictor 930 and the super macro block is performed by the combining unit 940, and thus, a differential block is generated. In this case, the transcoder 950 may perform transcoding of an output of the combining unit 940. The descriptions with reference to FIGS. 1 through 8 may be applicable to the quantizer 960 and the entropy coder 970 and thus, detailed descriptions thereof are omitted.

As described above, technologies applied to the intra coding apparatus of the present invention may be applied to the intra decoding apparatus. Accordingly, those skilled in the art may easily embody a corresponding intra decoding apparatus based on the technologies applied to the intra coding apparatus.

Although it is not illustrated in FIG. 9, the intra decoding apparatus may include a receiving unit to receive a bit stream generated by the intra coding apparatus. The intra decoding apparatus may include an entropy decoder to perform entropy decoding with respect to the bit stream, and may include a dequantizer to perform dequantizing of an output of the entropy decoder. In addition, the output of the dequantizer may be processed by a trans decoder, and the trans decoder may generate a differential block. In this case, an intra predictor of the intra decoding apparatus may perform an intra prediction and may restore the super macro block based on an intra prediction result and the differential block.

The intra decoding apparatus may be appropriately applied when the super macro block is divided into a plurality of macro blocks to be coded, in addition to when the super macro block is handled as a single entity while being coded. A flag may indicate whether the super macro block is handled as a single entity while being coded or whether the super macro block is divided into the plurality of blocks to be coded.

A case where the super macro block is handled as a single entity, and a case where the super macro block is divided into a plurality of macro blocks to be coded have been described. A technical concept of the present invention may be expanded to a slice level or to a picture level. A single super macro block includes a plurality of macro blocks, and sizes of the plurality of macro blocks may be different from each other. Similarly, a slice or a picture may be composed of a plurality of super macro blocks, and sizes of the super macro blocks may be different from each other. For example, a slice A may include a plurality of super macro blocks having sizes of 32×32, whereas, a slice B may be composed of blocks having different sizes, such as a super macro block having a size of 32×32, a super macro block having a size of 64×64, a super macro block having a size of 128×128, a macro block having a size of 16×16, and a macro block having a size of 8×8.

Information associated with a number of super macro blocks included in the slice or the picture, information associated with sizes of the super macro blocks, information associated with a number of macro blocks (included in the slice or the picture?), information associated with sizes of the macro blocks, and the like may be included in a slice header or a picture header. In this case, the intra decoding apparatus may recognize a configuration of the slice or the picture based on the information and thus, may use an appropriate decoding method.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

What is claimed is:

1. An intra coding method, the method comprising:
receiving a super macro block;
generating a bit stream by performing, with respect to the super macro block, an intra prediction, transcoding, quantizing, and entropy coding; and
marking a flag to indicate that the super macro block is handled as a single entity.

2. The method of claim 1, wherein the super macro block has a size of 16n×16n, n being a natural number greater than or equal to 2.

3. The method of claim 1, wherein the indicating comprises marking a first logical value when the super macro block is handled as the single entity, and marking a second logical value when the super macro block is divided into a plurality of blocks and each of the plurality of blocks is handled as a single entity.

4. The method of claim 2, wherein the generating comprises:
performing the intra prediction with respect to the super macro block using a prediction mode ‘Intra 32×32’, when n is 2,
wherein the prediction mode ‘Intra 32×32’ is defined based on a prediction mode ‘Intra 16×16’ that is applied to a macro block having a size of 16×16 among prediction modes defined based on a video compression standard H.264.

5. The method of claim 4, wherein the prediction mode ‘Intra 32×32’ includes a horizontal prediction mode, a vertical prediction mode, a DC (discrete cosine) prediction mode, and a plane prediction mode.

6. The method of claim 2, wherein the generating comprises:
performing an 8×8 integer cosine transformation with respect to differential blocks generated from the super macro block, when n is 2; and
collecting DC values generated by performing an integer cosine transformation, and performing, with respect to the collected DC values, a 4×4 Hadamard transformation that is applied to a macro block having a size of 16×16 among prediction modes defined based on a video compression standard H.264.

7. The method of claim 2, wherein the generating comprises:
performing an 8×8 integer cosine transformation with respect to differential blocks generated from the super macro block, when n is 2; and
collecting DC values generated by performing an integer cosine transformation, and performing, with respect to the collected DC values, a 2×2 Hadamard transformation that is applied to a macro block having a size of 16×16 among prediction modes defined based on a video compression standard H.264.

8. The method of claim 1, further comprising:
generating, for each super macro block, a parameter ‘smb_qp_delta’ associated with an error generated while the intra prediction with respect to each super macro block is performed.

9. The method of claim 1, further comprising:
marking a flag to indicate whether the super macro block is a last super macro block in a corresponding slice.

10. An intra coding method, the method comprising:
dividing a super macro block into M macro blocks, M being a natural number greater than or equal to 2;
generating a bit stream by performing, with respect to each of the M macro blocks, an intra prediction, transcoding, quantizing, and entropy coding; and
marking a flag to indicate that the super macro block is divided into M macro blocks.

11. The method of claim 10, wherein the super macro block has a size of 16n×16n, n being a natural number greater than or equal to 2.

12. The method of claim 10, wherein the marking the flag comprises marking a first logical value when the super macro block is handled as a single entity, and marking a second logical value when the super macro block is divided into M macro blocks and each of the macro blocks is handled as a single entity.

13. The method of claim 11, wherein the generating comprises:
performing the intra prediction with respect to each of the M macro blocks using a prediction mode ‘Modified Intra 16×16’, when n is 2 and M is 4, wherein the prediction mode ‘Modified Intra 16×16’ is defined based on a prediction mode ‘Intra 8×8’ that is applied to a macro block having a size of 8×8 among prediction modes defined based on a video compression standard H.264.

14. The method of claim 13, wherein the prediction mode ‘Modified Intra 16×16’ includes a vertical prediction mode, a horizontal prediction mode, a DC prediction mode, a diagonal down left prediction mode, a diagonal down right prediction mode, a vertical right prediction mode, a horizontal down prediction mode, a vertical left prediction mode, and a horizontal up prediction mode.

15. The method of claim 10, further comprising:
generating, for each super macro block, a parameter ‘smb_qp_delta’ associated with an error generated while the intra prediction with respect to each super macro block is performed.

16. The method of claim 10, further comprising:
marking a flag indicating whether the super macro block is a last super macro block in a corresponding slice.

17. The method of claim 14, further comprising:
indicating, based on a most probable mode (MPM) flag scheme, each of the vertical prediction mode, the horizontal prediction mode, the DC prediction mode, the diagonal down left prediction mode, the diagonal down right prediction mode, the vertical right prediction mode, the horizontal down prediction mode, the vertical left prediction mode, and the horizontal up prediction mode.

18. The method of claim 13, wherein the prediction mode ‘Modified Intra 16×16’ is defined based on a 16×16 inter transform that is used for an inter prediction with respect to the super macro block in KTA (key technical area) 2.3 software.

19. An intra coding apparatus, the apparatus comprising:
an intra predictor to receive a super macro block and to perform an intra prediction with respect to the super macro block;
a transcoder to perform transcoding with respect to differential blocks generated based on the super macro block and a result of the intra prediction; and
a quantizer to perform quantizing with respect to an output of the transcoder;
an entropy coder to perform coding with respect to an output of the quantizer to generate a bit stream,
wherein a flag is marked to indicate that the super macro block is handled as a single entity.

20. An intra coding apparatus, the apparatus comprising:
an intra predictor to divide a super macro block into M macro blocks, M being a natural number greater than or equal to 2, and to perform an intra prediction with respect to each of the M macro blocks;
a transcoder to perform transcoding with respect to differential blocks generated based on the M macro blocks and a result of the intra prediction;
a quantizer to perform quantizing an output of the transcoder; and
an entropy coder to perform entropy coding with respect to an output of the quantizer to generate a bit stream,
wherein a flag is marked to indicate that the super macro block is divided into the M macro blocks.

21. An intra decoding method, the method comprising:
receiving a bit stream corresponding to an intra-coded super macro block;
recognizing, based on a flag of the intra-coded super macro block, that a super macro block is handled as a single entity while the super macro block is intra coded; and
restoring the super macro block by performing, with respect to the bit stream, entropy decoding, dequantizing, trans decoding, and intra prediction in response to the recognizing.

22. The method of claim 21, wherein the restoring comprises:
performing the intra prediction with respect to the super macro block based on a prediction mode ‘Intra 32×32’ when the super macro block has a size of 16n×16n, n being a natural number greater than or equal to 2, and when n is 2,
wherein the prediction mode ‘Intra 32×32’ is applied to a macro block having a size of 16×16 among prediction modes defined in a video compression standard H.264.

23. An intra decoding method, the method comprising:
receiving a bit stream corresponding to an intra-coded super macro block;
recognizing, based on a flag of the intra-coded super macro block, that a super macro block is divided into M macro blocks, M being a natural number greater than or equal to 2, and intra coding is performed with respect to the M macro blocks; and
restoring the super macro block by performing, with respect to the bit stream, entropy decoding, dequantizing, trans decoding, and intra prediction in response to the recognizing.

24. The method of claim 23, wherein the restoring comprises:
performing the intra prediction with respect to each of the M macro blocks based on a prediction mode ‘Modified Intra 16×16’ when the super macro block has a size of 16n×16n, n being a natural number greater than or equal to 2, and when n is 2 and M is 4,
wherein the prediction mode ‘Modified Intra 16×16’ is defined based on a prediction mode ‘Intra 8×8’ that is applied to a macro block having a size of 8×8 among prediction modes defined in a video compression standard H.264.
